(19) United States
(12) Patent Application Publication
(10) Pub. No.: US 2024/0375590 A1
(43) Pub. Date: Nov. 14, 2024

(54) DISPLAY CONTROL SYSTEM AND DISPLAY CONTROL METHOD THEREOF

(71) Applicant: Honda Motor Co., Ltd., Tokyo (JP)

(72) Inventors: Haruko OKUYAMA, Saitama (JP); Tatsuya IWASA, Saitama (JP)

(73) Assignee: Honda Motor Co., Ltd., Tokyo (JP)

(21) Appl. No.: 18/628,788

(22) Filed: Apr. 7, 2024

(30) Foreign Application Priority Data
May 9, 2023 (CN) 202310514863.X

(51) Int. Cl. B60R 1/22; B60K 35/23; B60R 1/00; G02B 27/01

(52) U.S. Cl. CPC B60R 1/22; B60K 35/23; B60R 1/001; G02B 27/0101; B60R 2300/802

(57) ABSTRACT

The disclosure provides a display control system and a display control method thereof. The display control device controls the display device to display the location information image on the screen member based on the current location of the vehicle, map information, a captured image, and location information of a target recognition object. When the user is able to see the target recognition object, the display control device controls the display device to display the location information image representing the location information of the target recognition object in the first mode on the screen member. When the user is not able to see the target recognition object, the display control device controls the display device to display the location information image representing the location information of the target recognition object in a second mode on the screen member.

### CROSS-REFERENCE TO RELATED APPLICATION

This application claims the priority benefit of China application serial no. 202310514863.X, filed on May 9, 2023. The entirety of the above-mentioned patent application is hereby incorporated by reference herein and made a part of this specification.

### Technical Field

The disclosure relates to a control device, and more particularly to a display control system and a display control method thereof.

### Description of Related Art

In recent years, efforts to provide access to sustainable transportation systems that also take into account vulnerable persons among traffic participants have been active. In order to achieve the stated purpose, research and development efforts are made to further improve the safety or convenience of transportation through research and development related to preventive safety technologies.

In existing preventive safety technologies, sensors and cameras installed in vehicles detect risk targets that may cause collisions and notify drivers, but sensors and cameras that fail to detect risk targets do not provide relevant information to the driver, which makes it difficult for the driver to know the risk targets in the blind spot of the detection by searching for the risk targets only from the visible information.

Thus, how to improve preventive safety technology to further improve traffic safety and convenience is one of the major efforts.

### SUMMARY

The disclosure provides a display control system and a display control method thereof, which may provide the user of the vehicle with location information of a risk target in the detection blind spot, thereby greatly improving the driving safety of the vehicle and providing a sustainable transportation system that may improve traffic safety and convenience.

The display control system of the disclosure is adapted for vehicles, and the display control system includes a display control device. The display control device controls a display device to display a location information image representing location information of a target recognition object in a first mode on a screen member. The screen member is provided between the target recognition object and a user of the vehicle. The display control device includes a vehicle location identification unit. The vehicle location identification unit identifies a current location of the vehicle. The display control device controls the display device to display the location information image on the screen member based on the current location of the vehicle, map information of a road on which the vehicle is traveling, a captured image of an outside of the vehicle, and the location information of the target recognition object. When the user is able to see the target recognition object, the display control device controls the display device to display the location information image representing the location information of the target recognition object in the first mode on the screen member. When the user is not able to see the target recognition object, the display control device controls the display device to display the location information image representing the location information of the target recognition object in a second mode on the screen member.

The disclosure further provides a display control method of a display control system adapted for a vehicle, and the display control method of the display control system is described below. A current location of the vehicle is identified. The location information image representing location information of the target recognition object is displayed on a screen member based on the current location of the vehicle, map information of a road on which the vehicle is traveling, a captured image of an outside of the vehicle, and the location information of the target recognition object. The screen member is provided between the target recognition object and a user of the vehicle. Whether the user is able to see the target recognition object is determined. The location information image representing the location information of the target recognition object is displayed in a first mode on the screen member when the user is able to see the target recognition object. The location information image representing the location information of the target recognition object in is displayed a second mode on the screen member when the user is not able to see the target recognition object through the screen member.

Based on the above, the embodiment of the disclosure is capable of displaying the location information image representing the location information of the target recognition object on the screen member based on the current location of the vehicle, the map information, the captured image, and the location information of the target recognition object. The location information image representing the location information of the target recognition object is displayed in the first mode on the screen member when the user is able to see the target recognition object, and the location information image representing the location information of the target recognition object is projected in the second mode on the screen member when the user is not able to see the target recognition object. In this way, regardless of whether the user is able to see the target recognition object, the corresponding location information image of the target recognition object is provided, so that the user of the vehicle may know the location information of the target recognition object, thereby significantly improving the driving safety of the vehicle and providing a sustainable transportation system that may improve traffic safety and convenience.

In order to make the aforementioned features and advantages of the disclosure comprehensible, embodiments accompanied with drawings are described in detail below.

### BRIEF DESCRIPTION OF THE DRAWINGS

FIG. 1 is a schematic view of a display control system adapted for a vehicle according to the embodiment of the disclosure.

FIG. 2 is a schematic view of a projected location information image according to the embodiment of the disclosure.

FIG. 3 is a location schematic view of a vehicle with a display control system and a target recognition object according to the embodiment of the disclosure.

FIG. 4 is a schematic view of a projected location information image according to another embodiment of the disclosure.

FIG. 5 is a schematic view of a displayed location information image according to the embodiment of the disclosure.

FIG. 6 is a schematic view of a displayed location information image according to another embodiment of the disclosure.

FIG. 7 is a flow chart of a display control method of a display control system according to the embodiment of the disclosure.

### DESCRIPTION OF THE EMBODIMENTS

In order that the contents of the disclosure may be more comprehensible, the following embodiments are given as examples according to which the disclosure may be implemented. In addition, wherever possible, components/parts using the same reference numerals in the accompanying drawings and embodiments represent the same or similar parts.

In one embodiment of the disclosure, the location information image in the second mode has a central portion which is hollow and transparent.

In one embodiment of the disclosure, the screen member is a glass of the vehicle, and the display control device controls the display device to project the location information image on the screen member, so that the user is able to see the location information image superimposed on the target recognition object.

In one embodiment of the disclosure, the screen member is a display panel, the display control device controls the display device to display the location information image on the screen member, and the location information image is located on a virtual line between the user and the target recognition object.

In one embodiment of the disclosure, the location information image in the second mode has a central portion which is hollow and transparent.

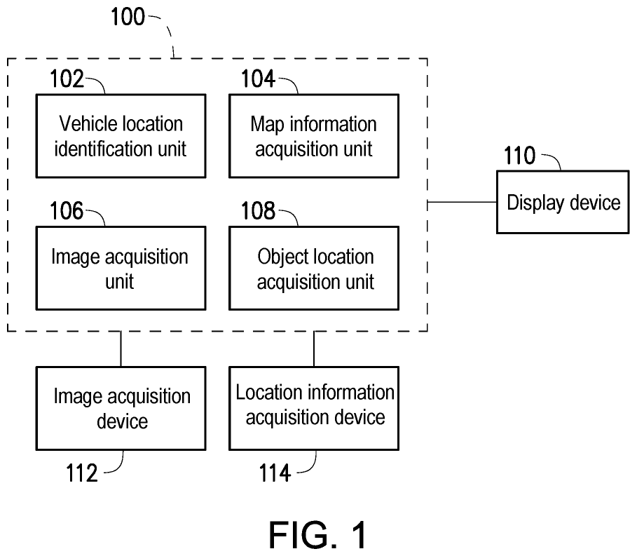

FIG. 1 is a schematic view of a display control system adapted for a vehicle according to the embodiment of the disclosure. Referring to FIG. 1, the display control system may include a display control device 100, and the display control device 100 may be coupled to a display device 110, an image acquisition device 112, and a location information acquisition device 114. The display device 110 may be, for example, a head-up display (HUD), and the display device 110 may display an image by projecting on the screen member, but is not limited thereto, for example, in some embodiments, the display device 110 may also be a liquid crystal display. The screen member is provided between the user of the vehicle (e.g., the driver) and the objects located outside the vehicle (e.g., other vehicles, pedestrians, bicycles, etc., but not limited thereto), and the screen member may be, for example, the front glass of the vehicle, but not limited thereto. In some embodiments, the screen member may also be, for example, the rear window or the side window glass. Alternatively, in the case where the display device 110 is a liquid crystal display, the screen member may be, for example, a display panel of the liquid crystal display. The image acquisition device 112 may be, for example, a camera, which is installed on the vehicle to capture the image outside the vehicle. For example, the image capturing may be performed in the traveling direction of the vehicle to generate a captured image, but it is not limited thereto. In the case where the image acquisition device 112 includes multiple cameras, the image acquisition device 112 may also capture images in different directions. The location information acquisition device 114 is configured to acquire location information of the object surrounding the vehicle, such as the location information of other vehicles, pedestrians, bicycles, etc., surrounding the vehicle. The location information acquisition device 114 may include, for example, a wireless communication device. In the case where the vehicle is able to communicate with surrounding objects, for example, when the objects around the vehicle are other vehicles or pedestrians that is able to communicate (such as pedestrians communicating through mobile phones), the location information acquisition device 114 may receive the location information of other vehicles from other vehicles or pedestrians' mobile phones through wireless communication. In the case where the vehicle is not able to communicate with the surrounding objects, for example, when the surrounding object is a pedestrian who is not able to communicate, the location information acquisition device 114 may, for example, through connecting to a cloud server, acquire information from a road monitoring camera (e.g., image information of pedestrians captured by the road monitoring camera and the location information of the road monitoring camera), thereby acquiring the location information of the pedestrian who is not able to communicate. In some embodiments, the location information acquisition device 114 may also include an image acquisition device 112, that is, the location information acquisition device 114 may also acquire the location information of the objects captured by the image acquisition device 112 based on the captured image of the image acquisition device 112.

As an example, in the case where the display device 110 is a head-up display, the display control device 100 may control the display device 110 to project the location information image representing the location information of the target recognition object in a first mode or a second mode on the screen member. The target recognition object may be, for example, objects that have a greater probability of colliding with the vehicle, such as other cars, pedestrians, or bicycles in the traveling direction of the vehicle. However, it is not limited thereto. The target recognition object may also be an object within a default range around the vehicle and not limited to the object in front of the vehicle. In addition, the first mode and the second mode correspond to different location information images, for example, corresponding to location information images of different shapes and colors. Further, the display control device 100 may include a vehicle location identification unit 102, a map information acquisition unit 104, an image acquisition unit 106, and an object location acquisition unit 108. The vehicle location identification unit 102, the map information acquisition unit 104, the image acquisition unit 106, and the object location acquisition unit 108 may be implemented by, for example, a processor, an electronic control unit (ECU), or a microcontroller unit (MCU), but is not limited thereto.

The vehicle location identification unit 102 is configured to identify the current location of the vehicle. For example, the vehicle location identification unit 102 may acquire the current location of the vehicle through a global positioning system (GPS) receiver. The map information acquisition unit 104 is configured to acquire map information including information about the road on which the vehicle is traveling, and the map information may be stored in, for example, a memory chip of the on-board computer, but is not limited thereto. The image acquisition unit 106 is configured to acquire the captured image provided by the image acquisition device 112. The object location acquisition unit 108 may acquire the location information of the target recognition object from the location information acquisition device 114.

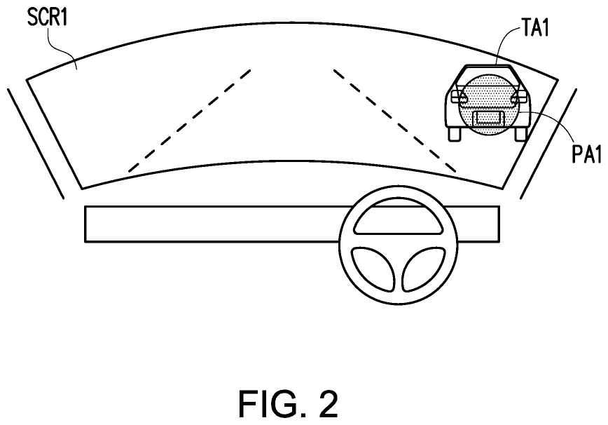

The display control device 100 may control the display device 110 to project the location information image in the first mode or the second mode on the screen member according to the current location of the vehicle, the map information, the captured image, and the location information of the target recognition object. Furthermore, the display control device 100 may determine whether the user of the vehicle is able to see the target recognition object through the screen member based on the based on the current location of the vehicle, the map information, the captured image, and the location information of the target recognition object. When it is determined that the user of the vehicle is able to see the target recognition object through the screen member, the display control device 100 may control the display device 110 to project the location information image representing the location information of the target recognition object in the first mode on the screen member. For example, as shown in FIG. 2, it is assumed that in the embodiment of FIG. 2, the screen member is the front glass SCR1 of the vehicle, and the target recognition object is a vehicle TA1 on the right front of the vehicle. The display control device 100 may control the display device 110 to project a location information image PA1 representing the location information of the vehicle TA1 in the first mode on the front glass SCR1, so that the user of the vehicle is able to see the location information image PA1 superimposed on the vehicle TA1. In this embodiment, the location information image PA1 is a solid circle pattern, but it is not limited thereto. In other embodiments, the location information image PA1 may also be, for example, a solid triangle pattern, a square pattern, or a pattern of other shapes. It is worth noting that in some embodiments, the display control device 100 may also control the display device 110 to project the location information image PA1 at other positions on the front glass SCR1, and is not limited to enabling the user of the vehicle to see the location information image PA1 superimposed on the vehicle TA1; that is, the display device 110 may also be controlled to project the location information image PA1 at a position near the vehicle TA1 instead of superimposing on the vehicle TA1 (from the perspective of the user of the vehicle). Alternatively, the display device 110 may also be controlled to project the location information image PA1 in other ways that may express the relative positional relationship between the vehicle driven by the user and the vehicle TA1, for example, to project the location information image PA1 at any position on the right half of the front glass SCR1, but not limited thereto.

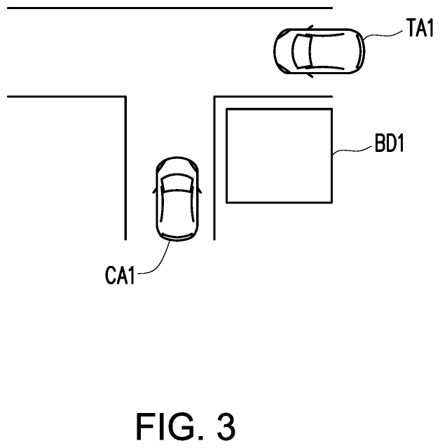

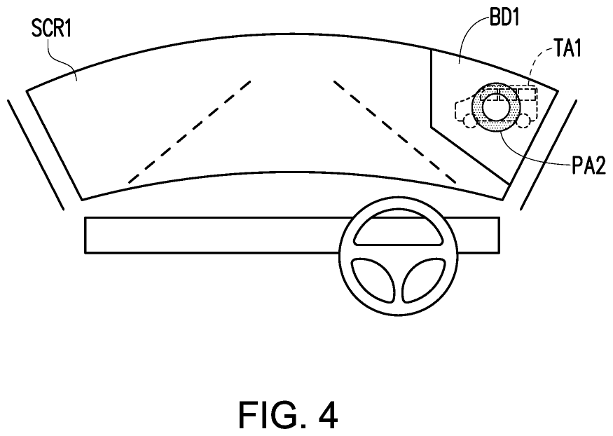

When the display control device 100 determines that the user is not able to see the target recognition object through the screen member, the display control device 100 may control the display device 110 to project the location information image representing the location information of the target recognition object in the second mode on the screen member, so that the user of the vehicle may know the location of the target recognition object through the projected location information image even though the user is not able to see the target recognition object directly. For example, as shown in FIG. 3, it is assumed that a vehicle CAI is a vehicle provided with the display control device 100, the vehicle TA1 is the target recognition object, and the user of the vehicle CA1 is not able to see the vehicle TA1 as being blocked by a building BD1. The display control device 100 may control the display device 110 to project a location information image PA2 representing the location information of the vehicle TA1 in the second mode on the front glass SCR1 as shown in FIG. 4, so that the user of the vehicle is able to see the location information image PA2 superimposed on the vehicle TA1. In this embodiment, the location information image PA2 is a circular pattern that has a central portion which is hollow and transparent. Similarly, the pattern of the location information image PA2 is not limited to that in the embodiment in FIG. 4, which may also be, for example, a triangle pattern, a square pattern, or a pattern of other shapes with a central portion which is hollow and transparent. In addition, in other embodiments, the display control device 100 may also control the display device 104 to project the information image PA2 at a location that is not superimposed on the vehicle TA1 (from the perspective of the user of the vehicle). In this way, regardless of whether the user of the vehicle CA1 is able to see the vehicle TA1 through the front glass SCR1, the corresponding location information image of the vehicle TA1 is provided, so that the user of the vehicle CA1 may know the location information of the vehicle TA1, thereby significantly improving the driving safety of the vehicle CA1 and providing a sustainable transportation system that may improve traffic safety and convenience.

It is worth noting that in the embodiments in FIG. 2 to FIG. 4, the front glass is used as an example for illustration. However, in other embodiments, the screen member is not limited to the front glass, for example, the screen member may also be the rear window. Similarly, the display control device 100 may also control the display device 110 to project the location information image representing the location information of the target recognition object in the first mode or the second mode on the rear window, so that when the user of the vehicle is performing backing, the location information of the target recognition object may also be known through the location information image on the rear window, which may improve the driving safety of the vehicle CA1. In addition, in the embodiment of FIG. 3, the object blocking the vehicle TA1 is the building BD1, but it is not limited thereto. In other embodiments, the object blocking the vehicle TA1 may also be, for example, other vehicles (such as large trucks) or other objects that may block the vehicle TA1. In some embodiments, the screen member may also be, for example, the side window glass. The display control device 100 may also control the display device 110 to project the location information image representing the location information of the target recognition object in the first mode or the second mode on the side window glass, thereby enabling the driver to have a more comprehensive grasp of the surrounding conditions of the vehicle CA1.

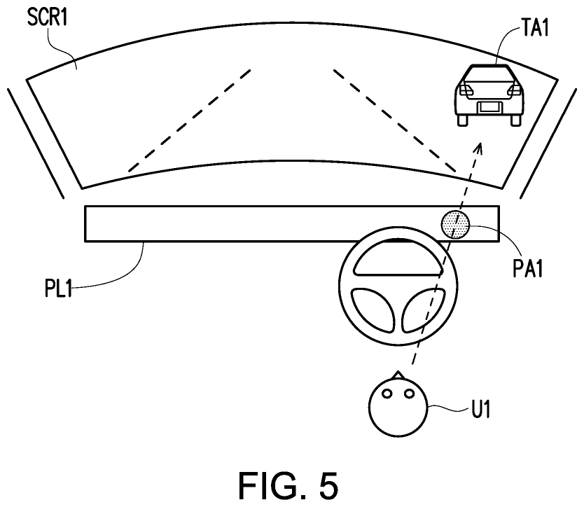

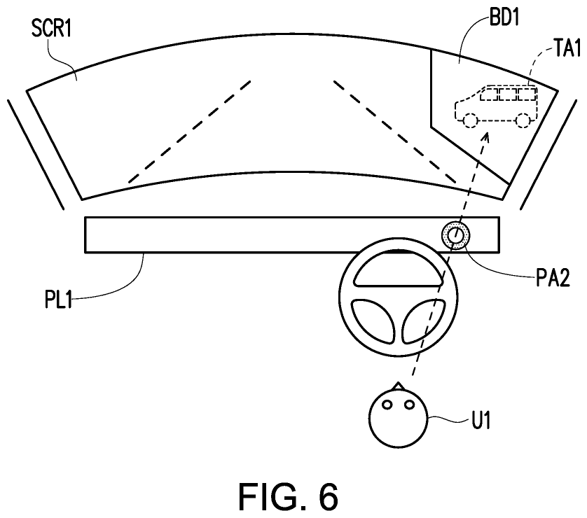

FIG. 5 and FIG. 6 are schematic views of the displayed location information image according to the embodiment of the disclosure. The difference between the embodiment in FIG. 5 and FIG. 6 and the above embodiment is that, in the embodiment of FIG. 5 and FIG. 6, the display device 110 may be implemented as, for example, a liquid crystal display, and the screen member is a display panel PL1 of the liquid crystal display in the embodiment of FIG. 5 and FIG. 6. FIG. 5 shows the situation where the user U1 of the vehicle is able to see the vehicle TA1, and the display control device 100 may control the display device 110 to display the location information image PA1 representing the location information of the vehicle TA1 in the first mode on the screen member. The location information image PA1 is located on a virtual line between the user U1 and the vehicle TA1 (as shown by the dashed line between the vehicle TA1 and the user U1), and this allows the user U1 to see the vehicle TA1 and the location information image PA1 simultaneously in his/her sight. Similarly, the location information image PA1 is not limited to a solid circle pattern. In other embodiments, the location information image PA1 may also be, for example, a solid triangle pattern, a square pattern, or a pattern of other shapes. In addition, FIG. 6 shows the situation where the user U1 of the vehicle is not able to see the vehicle TA1, and at this time, the display control device 100 may control the display device 110 to display the location information image PA2 representing the location information of the vehicle TA1 in the second mode on the screen member. Similarly, the location information image PA2 is located on the virtual line between the user U1 and the vehicle TA1 (as shown by the dashed line between the vehicle TA1 and the user U1), and this allows the user U1 to know the relative positional relationship between the vehicle TA1 and the vehicle driven by the user U1 through the displayed position of the location information image PA2. The pattern of the location information image PA2 is not limited to that in the embodiment in FIG. 6, which may also be, for example, a triangle pattern, a square pattern, or a pattern of other shapes with a central portion which is hollow and transparent.

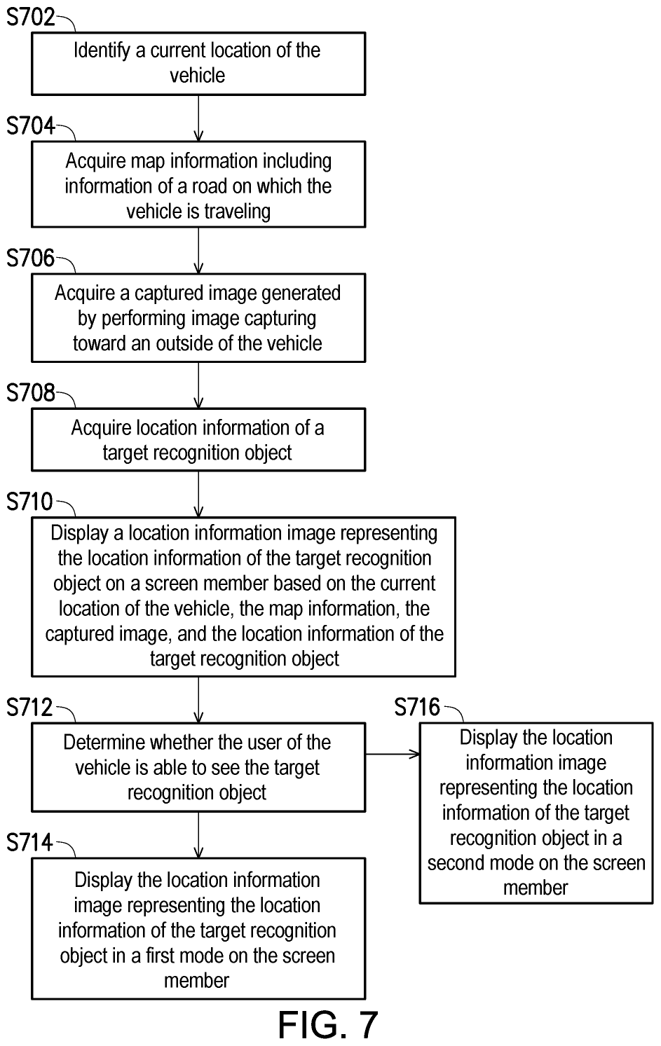

FIG. 7 is a flow chart of a display control method of a display control system adapted for a vehicle according to the embodiment of the disclosure. It may be seen from the above embodiment that the display control method of the display control system may include the following steps. First, a current location of the vehicle is identified (step S702). Next, map information including information of a road on which the vehicle is traveling is acquired (step S704). Then, a captured image generated by performing image capturing toward an outside of the vehicle is acquired (step S706). Afterwards, location information of a target recognition object is acquired (step S708). Then, a location information image representing the location information of the target recognition object is displayed on a screen member based on the current location of the vehicle, the map information, the captured image, and the location information of the target recognition object (step S710). The screen member is provided between the target recognition object and a user of the vehicle. Afterwards, whether the user of the vehicle is able to see the target recognition object through the screen member is determined (step S712). In the case where the user is able to see the target recognition object, the location information image representing the location information of the target recognition object is displayed in a first mode on the screen member (step S714). In the case where the user is not able to see the target recognition object, the location information image representing the location information of the target recognition object is displayed in a second mode on the screen member (step S716). The location information image in the first mode may be, for example, a solid pattern, while the location information image in the second mode may be, for example, a pattern that has a central portion which is hollow and transparent.

To sum up, the embodiment of the disclosure is capable of displaying the location information image representing the location information of the target recognition object on the screen member based on the current location of the vehicle, the map information, the captured image, and the location information of the target recognition object. The location information image representing the location information of the target recognition object is displayed in the first mode on the screen member when the user is able to see the target recognition object, and the location information image representing the location information of the target recognition object is displayed in the second mode on the screen member when the user is not able to see the target recognition object. In this way, regardless of whether the user is able to see the target recognition object, the corresponding location information image of the target recognition object is provided, so that the user of the vehicle may know the location information of the target recognition object, thereby significantly improving the driving safety of the vehicle and providing a sustainable transportation system that may improve traffic safety and convenience.

Although the disclosure has been disclosed by embodiments as above, it is not intended to limit the disclosure. Any person skilled in the art, without departing from the spirit and scope of the disclosure, may make certain changes and modifications so that the scope of protection of the disclosure shall be subject to the claims as defined.

What is claimed is:

1. A display control system adapted for a vehicle, comprising:
a display control device, controlling a display device to display a location information image representing location information of a target recognition object in a first mode on a screen member, wherein the screen member is provided between the target recognition object and a user of the vehicle, and the display control device comprises:
a vehicle location identification unit, identifying a current location of the vehicle,
wherein the display control device controls the display device to display the location information image on the screen member based on the current location of the vehicle, map information of a road on which the vehicle is traveling, a captured image of an outside of the vehicle, and the location information of the target recognition object,
when the user is able to see the target recognition object, the display control device controls the display device to display the location information image representing the location information of the target recognition object in the first mode on the screen member, and
when the user is not able to see the target recognition object, the display control device controls the display device to display the location information image representing the location information of the target recognition object in a second mode on the screen member.

2. The display control system according to claim 1, wherein the location information image in the second mode has a central portion which is hollow and transparent.

3. The display control system according to claim 1, wherein the screen member is a glass of the vehicle, and the display control device controls the display device to project the location information image on the screen member, so that the user is able to see the location information image superimposed on the target recognition object.

4. The display control system according to claim 1, wherein the screen member is a display panel, the display control device controls the display device to display the location information image on the screen member, and the location information image is located on a virtual line between the user and the target recognition object.

5. A display control method of a display control system adapted for a vehicle, comprising:
identifying a current location of the vehicle;
displaying a location information image representing location information of a target recognition object on a screen member based on the current location of the vehicle, map information of a road on which the vehicle is traveling, a captured image of an outside of the vehicle, and the location information of the target recognition object, wherein the screen member is provided between the target recognition object and a user of the vehicle;
determining whether the user is able to see the target recognition object;
displaying the location information image representing the location information of the target recognition object in a first mode on the screen member when the user is able to see the target recognition object; and
displaying the location information image representing the location information of the target recognition object in a second mode on the screen member when the user is not able to see the target recognition object.

6. The display control method of the display control system according to claim 5, wherein the location information image in the second mode has a central portion which is hollow and transparent.
